(19) United States
(12) Patent Application Publication
(10) Pub. No.: US 2024/0144531 A1
(43) Pub. Date: May 2, 2024

(54) KEYFRAME DETERMINATIONS FOR LOCALIZATION AND MAPPING

(71) Applicant: HEWLETT-PACKARD DEVELOPMENT COMPANY, L.P., Spring, TX (US)

(72) Inventors: Yow-Wei CHENG, Taipei City (TW); Ling-I Hung, Taipei City (TW)

(73) Assignee: HEWLETT-PACKARD DEVELOPMENT COMPANY, L.P., Spring, TX (US)

(21) Appl. No.: 17/975,458

(22) Filed: Oct. 27, 2022

(51) Int. Cl. G06T 7/80; G06T 7/11

(52) U.S. Cl. CPC G06T 7/80; G06T 7/11; G06T 2207/30244

(57) ABSTRACT

In one example in accordance with the present disclosure, a mobile device is described. The example mobile device includes an image sensor to capture an image frame. The example mobile device also includes a processor for performing simultaneous localization and mapping (SLAM). The example mobile device further includes a memory communicatively coupled to the processor and storing executable instructions that when executed cause the processor to: (1) determine a current location of the mobile device in a local map based on features extracted from the image frame; (2) perform a panoramic check to determine whether a threshold number of keyframes surrounding the current location have been captured; and (3) determine whether to add the image frame to a keyframe database for local mapping based on the panoramic check.

### BACKGROUND

Electronic technology has advanced to become virtually ubiquitous in society and has been used to enhance many activities in society. For example, electronic devices are used to perform a variety of tasks, including work activities, communication, research, and entertainment. Different varieties of electronic circuits may be utilized to provide different varieties of electronic technology. In some cases, electronic devices may be used to sense an environment.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a mobile device to perform keyframe determinations for localization and mapping, according to an example.

FIG. 2 is a table that illustrates minimum numbers of keyframes for different mage sensor parameters, according to an example.

FIG. 3 illustrates keyframe tables for different locations, according to an example.

FIG. 4 illustrates a specific example of keyframe tables for different locations.

FIG. 5 is a flow diagram illustrating a simultaneous localization and mapping (SLAM) process with a panoramic check, according to the examples described herein,

FIG. 6 depicts a non-transitory machine-readable storage medium for keyframe determinations for localization and mapping, according to an example.

FIG. 7 is a flow diagram illustrating a method for keyframe determinations for localization and mapping, according to an example.

FIG. 8 is a flow diagram illustrating another method for keyframe determinations for localization and mapping, according to an example.

Throughout the drawings, identical reference numbers designate similar, but not necessarily identical, elements. The figures are not necessarily to scale, and the size of some parts may be exaggerated to more dearly illustrate the example shown. Moreover, the drawings provide examples and/or implementations consistent with the description; however, the description is not limited to the examples and/or implementations provided in the drawings.

### DETAILED DESCRIPTION

In some examples, electronic devices may process image data to determine their location. For example, in the field of robotics and autonomous devices, a mobile device (e.g., a robot) that moves in free space may localize itself, meaning the mobile device determines its own location with respect to a point of reference or reference frame. Mobile devices may utilize reference maps to localize themselves. Examples of mobile devices include augmented reality (AR) devices, virtual reality (VR) devices, mixed reality (MR) devices, gaming consoles/controllers, drones, robots, autonomous vehicles, tablet devices, smartphones, notebook computers, etc.

Simultaneous localization and mapping (SLAM) is a process of constructing and updating a map of an environment while simultaneously keeping track of the location of the mobile within the environment. SLAM may be used by mobile devices for environment awareness via camera images (e.g., monocular images, color images, stereo images, depth images) with or without inertial measurement unit (IMU) sensor inputs. SLAM uses three processes that work simultaneously: tracking, local mapping, and loop closing. In the tracking process, frame-by-frame feature matching may be performed. Extracted feature points may be compared to a local map to determine the current location of the mobile device in real-time.

The tracking process may determine which keyframes are selected to be inserted into a keyframe database for the local map. There are multiple conditions to check if redundant keyframes should be included or deleted from the keyframe database. However, a completed SLAM tracking process may bring overhead to the host system that jeopardizes the overall system performance and impacts power consumption. One of the stages of the tracking process is to realize localization via camera images by comparing the extracted feature points of the current image frame with both a previous image frame and/or a retrieved keyframe. At the end of the tracking process, the tracking process determines if the current image frame should be added into the keyframe database as a new keyframe based on several predefined criteria. These stored keyframes are the anchor points used for future comparison with camera images for camera pose determination. However the number of keyframes being stored in the keyframe database occupies a considerable amount of memory of the mobile device. This keyframe storage slows down the local mapping process in SLAM.

This disclosure provides examples for reducing the overhead of the SLAM localization system when the mobile device is remains at a given location. For example, the mobile device may be standing-still. In another example, the mobile device may return to a given location after briefly moving to another location. In this case, the mobile device may be said to dwell in the given location. When a mobile device dwells in a location, the orientation of an image sensor of the mobile device may change. For example, when using an AR headset while seated, a user may turn their head such that an image sensor of the AR headset captures different views of the environment. When dwelling in a location, the number of keyframes added to the keyframe database may be reduced, thereby freeing up system resources that may be allocated to other jobs (e.g., graphics processing), Currently in SLAM processes, there is no executional difference between moving conditions or dwelling conditions

The present specification describes an adaptive SLAM process flow that reduces system resource consumption and enhances tracking performance under dwell conditions (e.g., sitting/standing-still use mode). The described examples provide for intelligently selecting keyframes to be stored in the keyframe database. The examples described herein simplify keyframe checking for dwell conditions (e.g., seated users, stationary robots, parked autonomous vehicles, etc.), which will reduce both memory consumption, power usage, and processing by a mobile device. In the described examples, the image sensor position may be used as a checking condition to reduce redundant keyframes inserted in the keyframe database for the map while the mobile device dwells in a given location. By reducing the number of keyframes, execution times of the local mapping and loop closing processes may be reduced, thereby reducing memory and power consumption.

In some examples, the present specification a mobile device is described. The example mobile device includes an image sensor to capture an image frame. The example mobile device also includes a processor for performing simultaneous localization and mapping (SLAM). The example mobile device further includes a memory communicatively coupled to the processor and storing executable instructions that when executed cause the processor to: (1) determine a current location of the mobile device in a local map based on features extracted from the image frame; (2) perform a panoramic check to determine whether a threshold number of keyframes surrounding the current location have been captured; and (3) determine whether to add the image frame to a keyframe database for local mapping based on the panoramic check.

In another example, the present specification also a non-transitory machine-readable storage medium comprising instructions executable by a processor to: (1) determine a current location of the mobile device in a local map based on features extracted from an image frame; (2) retrieve a keyframe table for the current location from a keyframe database; and (3) determine whether to add the image frame to the keyframe database for local mapping based on whether the keyframe table includes a threshold number of keyframes.

In yet another example, the present specification also describes a method by a mobile device. The method includes determining a current location of the mobile device in a local map based on features extracted from an image frame. The method also includes retrieving a keyframe table for the current location from a keyframe database. The method further includes determining that the keyframe table includes a threshold number of keyframes for the current location. The method additionally includes excluding the image frame from the keyframe database for local mapping in response to determining that the keyframe table includes a threshold number of keyframes for the current location.

As used in the present specification and in the appended claims, the term, “processor” may be a controller, an application-specific integrated circuit (ASIC), a semiconductor-based microprocessor, a central processing unit (CPU), a graphics processing unit (GPU), and a field-programmable gate array (FPGA), and/or other hardware device.

The memory may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

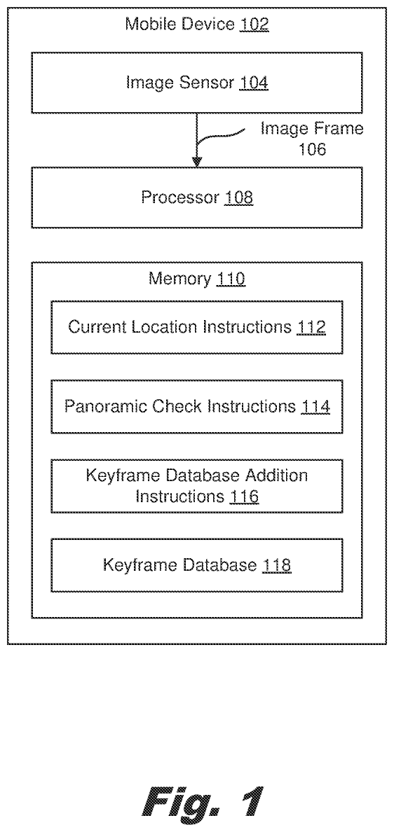

Turning now to the figures, FIG. 1 is a block diagram of a mobile device 102 to perform keyframe determinations for localization and mapping, according to an example. Some examples of the mobile device 102 include AR devices, VR devices, MR devices, gaming consoles/controllers, drones, robots, autonomous vehicles, tablet devices, smartphones, notebook computers, etc. In some examples, the mobile device 102 may be capable of moving itself. For example, the mobile device 102 include a propulsion system (not shown), For example, a robot may include wheels and motors to move. In some examples, the mobile device 102 may be moved by a user. For example, a user may wear an AR headset. It should be noted that while the mobile device 102 may be capable of movement, in some cases, the mobile device 102 may dwell in a given location.

The mobile device 102 may include an image sensor 104. In some examples, the image sensor 104 captures image frames 106. Examples of the image sensor 104 include cameras that capture monocular images, color images, stereo images, and/or depth images.

The mobile device 102 includes a processor 108. The processor 108 of the mobile device 102 may be implemented as dedicated hardware circuitry. In some examples, the dedicated hardware circuitry may be implemented as a controller (e.g., an embedded controller), an application-specific integrated circuit (ASIC), a semiconductor-based microprocessor, a central processing unit (CPU), and a field-programmable gate array (FPGA), and/or other hardware device.

In some examples, a memory 110 may be implemented in the mobile device 102. The memory 110 may be dedicated hardware circuitry to host instructions for the processor 108 to execute. The memory 110 may take many types of memory including volatile and non-volatile memory. For example, the memory 110 may include Random Access Memory (RAM), Read Only Memory (ROM), optical memory disks, and magnetic disks, among others.

The mobile device 102 may also include instructions. The instructions may be implemented in a platform specific language that the processor 108 may decode and execute. The instructions may be stored in the memory 110 during execution. In some examples, the instructions may include instructions to determine whether to add an image frame 106 to a keyframe database 118, according to the examples described herein. For example, the processor 108 may execute instructions to perform SLAM operations. The instructions may cause the processor 108 to determine whether to add or exclude an image frame 106 from the keyframe database 118 for a local map in SLAM.

The memory 110 may include current location instructions 112 that cause the processor 108 to determine a current location of the mobile device 102 in a local map based on features extracted from an image frame 106 captured by the image sensor 104. For example, the processor 108 may extract features from current image frame 106. The processor 108 may then compare the extracted features to a prior image frame or a keyframe retrieved from the keyframe database 118 used for the local map. Based on this comparison, the processor 108 may determine the current location of the mobile device 102 in the local map.

In some examples, the current location may be defined based on coordinates. For example, the current location may be a set of three-dimensional (3D) coordinates (e.g., x, y, z coordinates) within the local map. If the mobile device 102 is moving through an environment, the coordinates of the current location may change from the previous location. However, if the mobile device 102 stays at a given location or returns to the given location, the coordinates for the given location may match a previous location.

In some examples, the processor 108 may execute panoramic check instructions 114 to cause the processor 108 to perform a panoramic check to determine whether a threshold number of keyframes (also referred to as a panoramic minimum threshold) surrounding the current location have been captured. As used herein, a “panorama” is a wide-angle view or representation of a physical space. A 360-degree panorama is a panoramic view that surrounds a given location from which an image frame 106 is captured. 360-degree views may simulate being in the shoes of a photographer and looking around to the left, right, up, and down as desired. If the keyframes being captured and stored for a given location (e.g., xₛ, yₛ, zₛ) could conceptually be used to build a 360-degree panorama, all trackable feature points around the given location (e.g., xₛ, yₛ, zₛ) are being identified and saved. Thus, camera poses for that given location become fully trackable. As a result, future image frames captured at the given location (e.g., xₛ, yₛ, zₛ) should no longer be determined as a keyframe to be added into the keyframe database 118.

Thus, the processor 108 may perform a panoramic check by determining whether a threshold number of keyframes have been captured for a current location such that a 360-degree field of view of the current location could be generated using the keyframes stored in the keyframe database 118. It should be noted that for the panoramic check, the processor 108 does not generate a 360-degree panoramic image. Rather, the processor 108 checks to determine whether a sufficient number of keyframes have been saved in the keyframe database 118 to fully capture a 360-degree view of the location. Thus, the panoramic check indicates that that all the feature points around the current location are being captured and tracked.

In some examples, the panoramic check may be based on a threshold number of keyframes for a given location. For example, the processor 108 may determine whether a minimum number of keyframes (e.g., the panoramic minimum threshold) have been captured at the current location. The minimum number of keyframes may be based on a 360-degree field of view of the current location. Thus, the minimum number of keyframes may be the number of keyframes that are sufficient to capture a 360-degree view of the location.

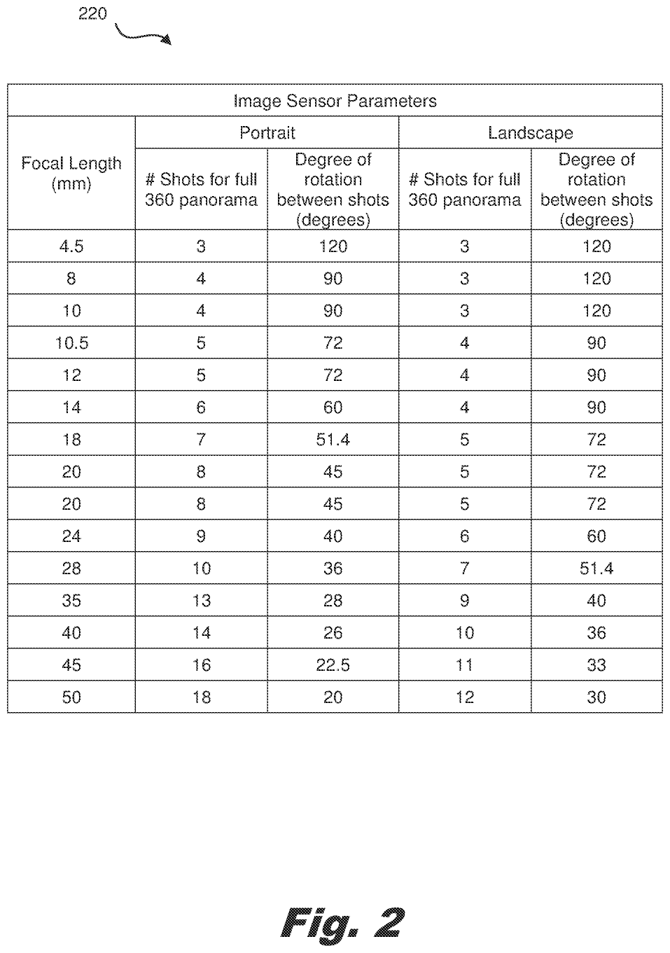

In some examples, minimum number of keyframes may be based on parameters of the image sensor 104 that is used to capture image frames 106. FIG. 2 is a table 220 that illustrates examples of minimum numbers of keyframes for different image sensor parameters. Referring briefly to FIG. 2, a given image sensor may be oriented in either portrait or landscape orientations. Furthermore, the given image sensor may capture image frames using a given focal length. In FIG. 2, the minimum number of keyframes to capture a full 360-panoramic view is referred to as the “#Shots,” FIG. 2 also depicts the degree of image sensor rotation between shots (i.e., image frames). Thus, for an example image sensor in portrait mode with a focal length of 4.5 mm, 3 keyframes with 120 degrees of rotation between the keyframes will capture a full 360-panoramic view. In another example, for the same example image sensor in landscape mode with a focal length of 50 mm, 12 keyframes with 30 degrees of rotation between the keyframes will capture a full 360-panoramic view.

Determining whether a threshold number of keyframes surrounding the current location have been captured may based on a camera pan and tilt angle. For example, in FIG. 2, the camera pan is expressed as the degree of rotation between shots. In other words, to fully capture an environment from a given location, the image sensor may rotate (i.e., pan) about an axis (e.g., vertical axis) to view the environment. Furthermore, the image sensor may tilt up and down to fully capture the vertical view of an environment. Therefore, the threshold number of keyframes may be based on the tilt angle of the image sensor when capturing image frames.

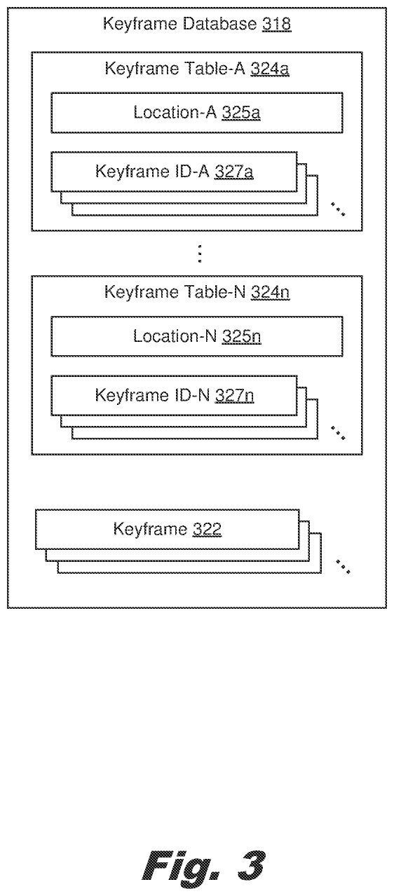

Returning now to FIG. 1, the processor 108 may maintain a keyframe table for the current location in the keyframe database 118 to facilitate the panoramic check. The processor 108 may maintain a separate keyframe table for each location to map keyframes stored in the keyframe database 118 to a given location. FIG. 3 illustrates an example of keyframe tables for different locations.

Referring to FIG. 3, a processor (e.g., FIG. 1, 108) may maintain a keyframe database 318 that is used to store keyframes 322 for a local map. For a given location, the processor may maintain a keyframe table in the keyframe database 318. In FIG. 3, the keyframe database 318 includes multiple keyframe tables for multiple locations. For example, keyframe table-A 324a may be maintained for location-A 325a (e.g., xₐ, yₐ, zₐ), table-N 324n may be maintained for location-N 325n (e.g., xₙ, yₙ, zₙ), and so forth. Each keyframe table 324 may include keyframe IDs 327 that map to a given keyframe 322 stored in the keyframe database 318. A given keyframe ID 327 refers to a given keyframe 322. For example, a keyframe ID 327a in keyframe Table-A 324a may refer to a first keyframe 322 while a second keyframe ID 327n in keyframe Table-N 324n may refer to a second keyframe 322n.

In some examples, the number of keyframe IDs stored in a given keyframe table may be based on the threshold number of keyframes to represent a 360-degree field of view of the location associated with the keyframe table. For example, the number of keyframe IDs stored in a given keyframe table may be based on image sensor parameters as discussed in FIG. 2. In other words, the number of keyframe IDs stored in a given keyframe table may correspond to the number of keyframes 322 that are used to cover a panoramic field of view of a given location.

The number of keyframe IDs stored in a given keyframe table may also be based on the pan and tilt of the image sensor pose. For example, a processor may determine whether pan and tilt of the keyframes associated with a given location cover the entire field of view covering the 360 panorama.

Referring again to FIG. 1, the processor 108 may execute keyframe database addition instructions 116 to cause the processor 108 to determine whether to add the image frame 106 to the keyframe database 118 for local mapping based on the panoramic check. For example, the processor 108 may exclude the image frame 106 from the keyframe database 118 in response to determining that the threshold number of keyframes surrounding the current location have been captured. For example, the processor 108 may check a keyframe table for the current location, as described in FIG. 3. If the keyframe table includes the threshold number of keyframes, then the processor 108 may exclude the current image frame 106 from further processing by the local mapping process.

If the processor 108 determines that the threshold number of keyframes surrounding the current location have not been captured, then the processor 108 may add the image frame 106 to the keyframe database 118. For example, the processor 108 may check the keyframe table for the current location, as described in FIG. 3. If the keyframe table does not include the threshold number of keyframes, then the processor 108 may provide the current image frame 106 to the local mapping process to determine whether the image frame 106 is added to the keyframe database 118. In some examples, the local mapping process adds the image frame 106 as a keyframe in the keyframe database 118 if the image frame 106 differs a given amount from other keyframes. If the image frame 106 is added as a keyframe to the keyframe database 118, then the processor 108 may add a keyframe ID (e.g., FIG. 3, 327a) to that keyframe in the keyframe table (e.g., FIG. 3, 325a) for the current location. In this manner, the keyframe table for a given location may be populated until a threshold number of keyframes are associated with the given location.

In some examples, adding the image frame 106 to the keyframe database 118 may include performing local mapping using the image frame 106. For example, in response to determining that the threshold number of keyframes surrounding the current location have not been captured, the local mapping process may use the image frame 106 as a keyframe in the local map.

In some examples, the processor 108 may repeatedly perform a scan at the current location as the mobile device remains at the current location. For example, the processor 108 may continue to capture image frames 106 and determine whether the image frames 106 are to be added to or excluded from the keyframe database 118. Thus, while the mobile device 102 remains located at a given location, the image sensor 104 may be positioned to capture different views of the environment surrounding the given location. The processor 108 may add captured image frames 106 as keyframes in the keyframe database 118 until a threshold number of keyframes are stored for the given location. Once the threshold number of keyframes is reached, the processor 108 may exclude further image frames 106 captured at the given location from being processed to become keyframes. Thus, the processing, memory, and power consumption may be reduced by excluding the captured image frames 106 from the keyframe database 118 when the threshold number of keyframes for a location has been reached.

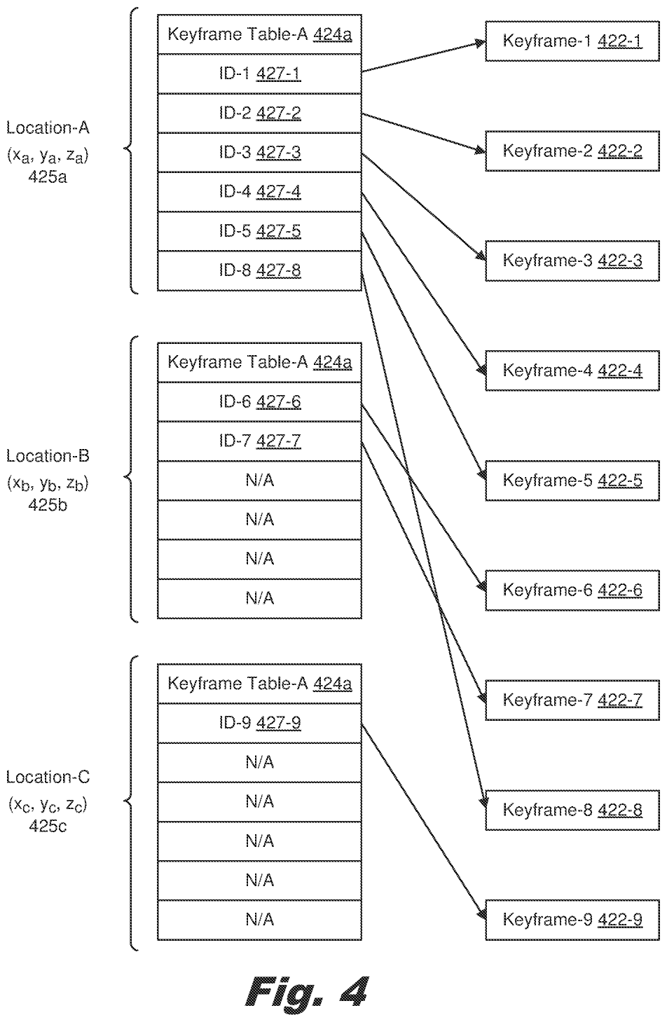

FIG. 4 illustrates keyframe tables 424a-c for different locations 425a-c, according to an example. As described in FIG. 3, the processor may maintain a separate keyframe table for each location. Thus, in the example of FIG. 4, the processor maintains a first keyframe table 424a for Location-A (xₐ, yₐ, zₐ) 425a, a second keyframe table 424b for Location-B (x_{b}, y_{b}, z_{b}) 425b, and a third keyframe table 424c for Location-C (x_{c}, y_{c}, z_{c}) 425c.

While the mobile device is located at Location-A (xₐ, yₐ, zₐ) 425a, five keyframes 422-1-422-5 are captured and associated with keyframe IDs 427-1-427-5 in keyframe table 424a. The mobile device then moves to Location-B (x_{b}, y_{b}, z_{b}) 425b where two keyframes 422-6 and 422-7 are captured and associated with two keyframe IDs 427-6, 427-7 in keyframe table 424b. The mobile device then moves back to Location-A (xₐ, yₐ, zₐ) 425a where keyframe-8 422-8 is captured and associated with a keyframe ID 427-8 in keyframe table 424a Finally, the mobile device moves to Location-C (x_{c}, y_{c}, z_{c}) 425c where keyframe-9 422-9 is captured and associated with a keyframe ID 427-9 in keyframe table 424c.

It should be noted that keyframe table 424a for Location-A (xₐ, yₐ, zₐ) 425a has met the minimum number of keyframes for constructing a 360 panorama of Location-A (xₐ, yₐ, zₐ) 425a Also for Location-A (xₐ, yₐ, zₐ) 425a, the pan and tilt of the camera poses (relative to Keyframe-1 422-1) of the associated keyframes cover the entire field of view for 360 panorama. This results in all feature points around Location-A (xₐ, yₐ, zₐ) being captured and tracked. Thus, future image frames may be excluded as keyframes in the keyframe database.

On the other hand, for Location-B (x_{b}, y_{b}, z_{b}) 425b and Location-C (x_{c}, y_{c}, z_{c}) 425c, the keyframe tables 424b,c are not fully populated with associated keyframes, where empty keyframe ID fields are represented as “N/A”. Thus, when the mobile device captures additional image frames at Location-B (x_{b}, y_{b}, z_{b}) 425b or Location-C (x_{c}, y_{c}, z_{b}) 425c, the mobile device may provide the captured image frames to the local mapping process to be considered for addition as keyframes. If these future image frames are stored as keyframes, the processor may record these keyframes in the associated keyframe table.

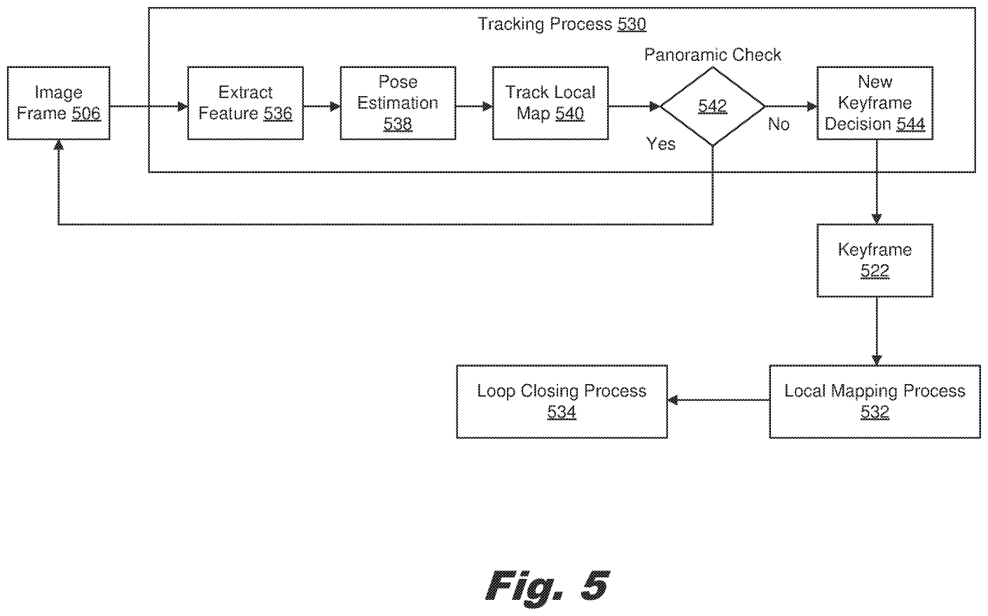

FIG. 5 is a flow diagram illustrating a SLAM process with a panoramic check, according to the examples described herein. As described above, the SLAM process may include a tracking process 530, a local mapping process 532, and a loop closing process 534.

An image frame is captured at 506. The image frame may be provided to the tracking process 530, which, at 536, extracts features from the image frame. At 538, the tracking process 530 may perform an initial pose estimation from the last image frame, or a re-localization. At 540, the tracking process 530 may track the image frame in the local map. For example, the tracking process 530 may determine the current location of the mobile device based on a comparison of extracted features to keyframes in the local map.

At 542, the tracking process 530 may perform a panoramic check. This panoramic check is intended as a quick check to determine whether the feature points surrounding the current location reported by “Track Local Map” 540 are captured or not. If the panoramic check fails (542, NO), then the tracking process 530 further moves to a New Keyframe Decision at 544 to decide if the current image frame is stored as a new keyframe. If the New Keyframe Decision at 544 determines that the image frame is to be a keyframe for the current location, the image frame may be stored as a keyframe 522 in the keyframe database.

In some examples, the keyframe 522 may then be provided to the local mapping process 532, which processes the keyframe 522 to crop out feature points and ensures that the keyframe database is efficient. In some examples, the keyframe 522 may also be provided to the loop closing process 534, which may relate (e.g., fuse) a current location with an origin location.

If the panoramic check succeeds (542, YES), then the tracking process 530 excludes the current image frame from further processing by the New Keyframe Decision at 544. Instead, the tracking process 530 may return to 506 to acquire a new image frame.

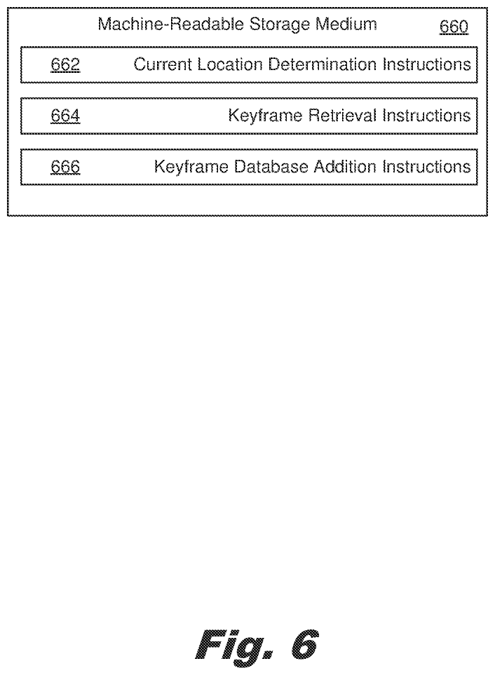

FIG. 6 depicts a non-transitory machine-readable storage medium 660 for keyframe determinations for localization and mapping, according to an example. To achieve its desired functionality, an electronic device (e.g., mobile device 102) includes various hardware components. Specifically, an electronic device includes a processor (e.g., processor 108) and a machine-readable storage medium 660. The machine-readable storage medium 660 is communicatively coupled to the processor. The machine-readable storage medium 660 includes a number of instructions 662, 664, 666 for performing a designated function. The machine-readable storage medium 660 causes the processor to execute the designated function of the instructions 662, 664, 666. The machine-readable storage medium 660 can store data, programs, instructions, or any other machine-readable data that can be utilized to operate the electronic device. Machine-readable storage medium 660 can store computer readable instructions that the processor of the mobile device 102 can process or execute. The machine-readable storage medium 660 can be an electronic, magnetic, optical, or other physical storage device that contains or stores executable instructions. Machine-readable storage medium 660 may be, for example, Random Access Memory (RAM), an Electrically Erasable Programmable Read-Only Memory (EEPROM), a storage device, an optical disc, etc. The machine-readable storage medium 660 may be a non-transitory machine-readable storage medium 660, where the term “non-transitory” does not encompass transitory propagating signals.

Referring to FIG. 6, current location determination instructions 662, when executed by the processor, may cause the processor to determine a current location of the mobile device in a local map based on features extracted from an image frame. Keyframe retrieval instructions 664, when executed by the processor, may cause the processor to retrieve a keyframe table for the current location from a keyframe database. Keyframe database addition instructions 666, when executed by the processor, may cause the processor to determine whether to add the image frame to the keyframe database for local mapping based on whether the keyframe table includes a threshold number of keyframes.

In some examples, the processor adds the image frame to the keyframe database in response to determining that the keyframe table does not include the threshold number of keyframes. The threshold number of keyframes may be based on a panoramic field of view of the current location. The processor may exclude the image frame from the keyframe database in response to determining that the keyframe table does not include the threshold number of keyframes.

In some examples, the processor executes the instructions to repeatedly perform a scan of image frames captured at the current location as the mobile device remains at the current location,

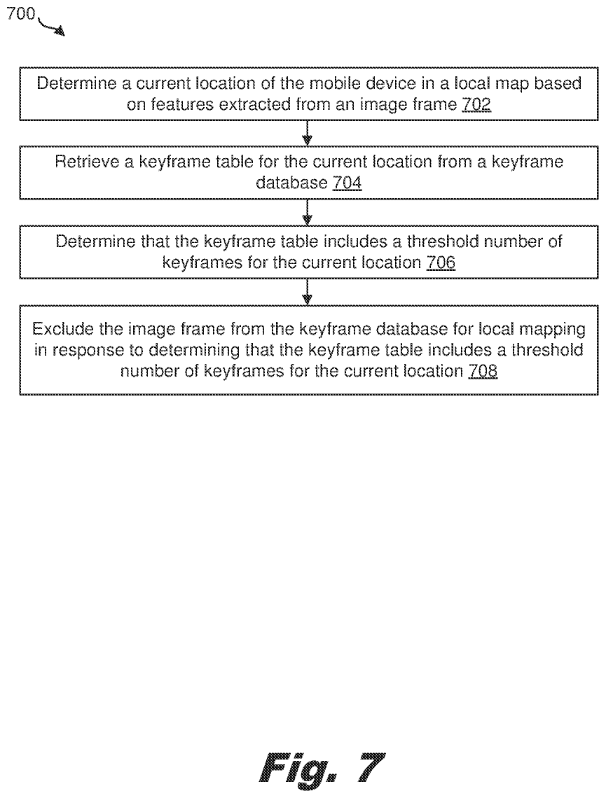

FIG. 7 is a flow diagram illustrating a method 700 for keyframe determinations for localization and mapping, according to an example. In some examples, the method 700 may be performed by a mobile device (e.g., FIG. 1, 102).

At 702, the mobile device determines a current location of the mobile device in a local map based on features extracted from an image frame. For example, an image sensor may capture an image frame. A tracking process may extract features from the image frame. By comparing the extracted features to keyframes in a keyframe database, the mobile device may determine the current location.

At 704, the mobile device may retrieve a keyframe table for the current location from a keyframe database. For example, the mobile device may maintain a keyframe table for the current location in the keyframe database. The keyframe table may associate (e.g., map) keyframes to the current location.

At 706, the mobile device may determine that the keyframe table includes a threshold number of keyframes for the current location. For example, the threshold number of keyframes may be based on a number of keyframes to represent a panoramic field of view of the current location. In some examples, the panoramic field of view may be a 360-degree field of view of the current location. In some examples, the mobile device may determine pan and tilt angles between keyframes in the keyframe table to determine the threshold number of keyframes for the current location.

At 708, the mobile device may exclude the image frame from the keyframe database for local mapping in response to determining that the keyframe table includes a threshold number of keyframes for the current location. For example, the mobile device may determine that the keyframe table for the current location includes the threshold number of keyframe IDs associated with keyframes. In some examples, the mobile device may also exclude the image frame from the keyframe database in response to determining that the pan and tilt angles between the keyframes included in the keyframe table cover a panoramic field of view of the current location,

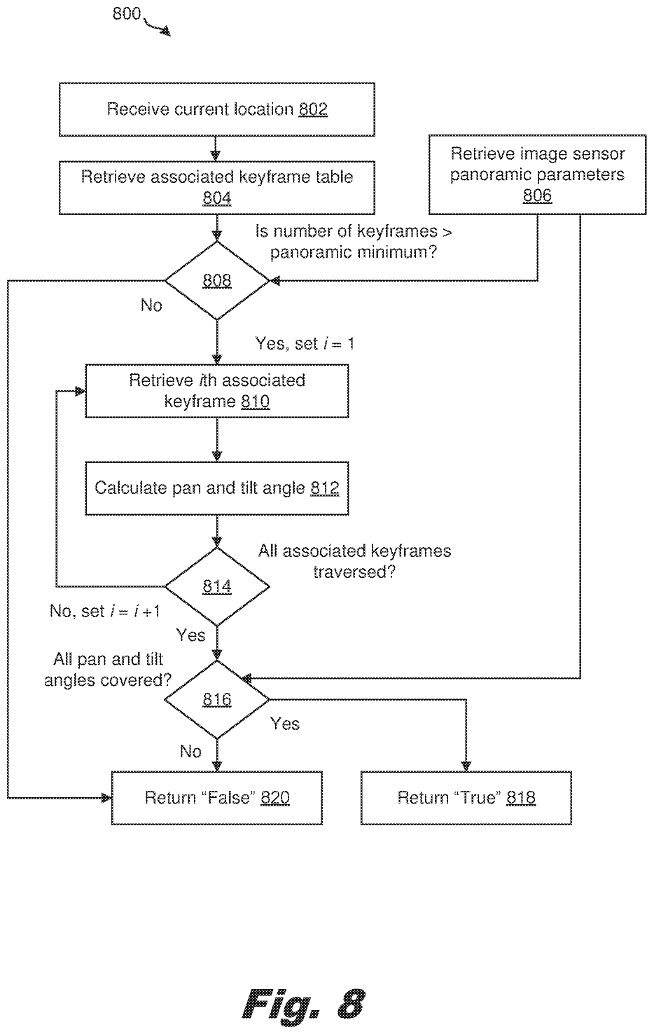

FIG. 8 is a flow diagram illustrating another method 800 for keyframe determinations for localization and mapping, according to an example. In some examples, the method 800 may be performed by a mobile device (e.g., FIG. 1, 102).

At 802 the mobile device receives the current position (e.g., x, y, z) from the track local map function of the SLAM track process. At 804, the mobile device retrieves a keyframe table associated with the current position.

At 806, the mobile device retrieves image sensor parameters. For example, parameters used by the panoramic check, such as minimum keyframe counts, camera pan angle, camera tilt angle may vary with both hardware and software discrepancies. For example, camera focal length, camera orientation, frame overlapping percentage may vary from one mobile device to another. These image sensor parameters may be provided to the panoramic check process at 808. For example, the panoramic check process may access resources file(s) or the image sensor hardware to read the image sensor parameters.

At 808, the mobile device may determine whether the number of keyframes included in the keyframe table is greater than a panoramic minimum threshold. If the mobile device determines that the number of keyframes included in the keyframe table is greater than a panoramic minimum threshold (808, YES), then the mobile device may set i=1. At 810, the mobile device may retrieve the ith keyframe associated by the keyframe table to the current location. At 812, the mobile device may calculate the pan and tilt angle between camera pose of the ith associated keyframe and the first associated keyframe.

At 814, the mobile device may determine whether all of the associated keyframes for the current location have been traversed. For example, the mobile device may determine whether each of the keyframes associated with keyframe IDs in the keyframe table have been checked. If 814 is NO, then the mobile device may set i=i+1, and may retrieve the ith keyframe associated by the keyframe table to the current location at 810.

If 814 is YES, then the mobile device may determine, at 816, whether all of the pan and tilt angles for a panoramic view have been covered. For example, the mobile device may check the image sensor panoramic parameters to determine whether the keyframes fully represent a panoramic view. It should be noted that the mobile device does not actually try to build panoramic image using the keyframes. Instead, the panoramic check by the mobile device is aimed at providing a faster SLAM system design. If 816 is NO, then the mobile device may return “FALSE” for the panoramic check at 820. In this case, the mobile device may further process the current image frame for addition to the keyframe database. Similarly, if 808 is NO (i.e., the number of keyframes for the current location is less than the panoramic minimum threshold), then the mobile device may return “FALSE” for the panoramic check at 820.

If 816 is YES, then the mobile device may return “TRUE” for the panoramic check at 818. In this case, the mobile device may exclude the current image frame from the keyframe database. In other words, the panoramic check determines that the keyframes associated with the current location fully represent a panoramic view of the current location. Thus, further keyframes for the current location may be avoided.

The above specification, examples, and data provide a description of the devices, processes and methods of the disclosure. Because many examples can be made without departing from the spirit and scope of the disclosure, this specification sets forth some of the many possible example approaches and implementations.

What is claimed is:

1. A mobile device comprising:
an image sensor to capture an image frame; and
a processor for performing simultaneous localization and mapping (SLAM);
a memory communicatively coupled to the processor and storing executable instructions that when executed cause the processor to:
determine a current location of the mobile device in a local map based on features extracted from the image frame;
perform a panoramic check to determine whether a threshold number of keyframes surrounding the current location have been captured; and
determine whether to add the image frame to a keyframe database for local mapping based on the panoramic check.

2. The mobile device of claim 1, wherein the processor is to exclude the image frame from the keyframe database in response to determining that the threshold number of keyframes surrounding the current location have been captured.

3. The mobile device of claim 1, wherein the processor is to add the image frame to the keyframe database in response to determining that the threshold number of keyframes surrounding the current location have not been captured.

4. The mobile device of claim 1, wherein the processor is to perform local mapping using the image frame in response to determining that the threshold number of keyframes surrounding the current location have not been captured.

5. The mobile device of claim 1, wherein the panoramic check comprises the processor to determine that a minimum number of keyframes have been captured at the current location.

6. The mobile device of claim 5, wherein the minimum number of keyframes is based on a 360-degree field of view of the current location.

7. The mobile device of claim 1, wherein determining whether a threshold number of keyframes surrounding the current location have been captured is based on a camera pan and tilt angle.

8. A non-transitory machine-readable storage medium comprising instructions executable by a processor to:
determine a current location of a mobile device in a local map based on features extracted from an image frame;
retrieve a keyframe table for the current location from a keyframe database; and
determine whether to add the image frame to the keyframe database for local mapping based on whether the keyframe table includes a threshold number of keyframes.

9. The non-transitory machine-readable storage medium of claim 8, wherein the processor executes the instructions to repeatedly perform a scan of image frames captured at the current location as the mobile device remains at the current location.

10. The non-transitory machine-readable storage medium of claim 8, wherein the processor executes the instructions to add the image frame to the keyframe database in response to determining that the keyframe table does not include the threshold number of keyframes.

11. The non-transitory machine-readable storage medium of claim 8, wherein the processor executes the instructions to exclude the image frame from the keyframe database in response to determining that the keyframe table does not include the threshold number of keyframes.

12. The non-transitory machine-readable storage medium of claim 8, wherein the threshold number of keyframes is based on a panoramic field of view of the current location.

13. A method by a mobile device, the method comprising:
determining a current location of the mobile device in a local map based on features extracted from an image frame;
retrieving a keyframe table for the current location from a keyframe database;
determining that the keyframe table includes a threshold number of keyframes for the current location; and
excluding the image frame from the keyframe database for local mapping in response to determining that the keyframe table includes a threshold number of keyframes for the current location.

14. The method of claim 13, further comprising determining pan and tilt angles between keyframes in the keyframe table.

15. The method of claim 14, further comprising excluding the image frame from the keyframe database in response to determining that the pan and tilt angles between the keyframes included in the keyframe table cover a panoramic field of view of the current location.
